(19) United States
(12) Patent Application Publication
(10) Pub. No.: US 2018/0171105 A1
(43) Pub. Date: Jun. 21, 2018

(54) RUBBER COMPOSITION THAT CAN BE CROSS-LINKED BY MEANS OF AMINE AND THAT HAS A LIGHT-COLORED FILLER

(71) Applicant: Schill+Seilacher "Struktol" GmbH, Hamburg (DE)

(72) Inventors: Volker Börger, Hamburg (DE); Dörte Becker, Hamburg (DE); Manfred Hensel, Tostedt (DE)

(21) Appl. No.: 15/736,183

(22) PCT Filed: Jun. 24, 2016
(86) PCT No.: PCT/EP2016/064667

§ 371 Date: Dec. 13, 2017

(30) Foreign Application Priority Data
Jun. 26, 2015 (EP) 15174187.3

(51) Int. Cl. C08K 5/14; C08K 5/17; C08K 5/00; C08L 15/00; C08L 21/00

(52) U.S. Cl. CPC C08K 5/14; C08K 5/17; C08L 83/04; C08L 15/00; C08L 21/00; C08K 5/0025

(57) ABSTRACT

The invention relates to a vulcanizable rubber composition which comprises a) one or more rubbers cross-linkable by means of amine, b) one or more white fillers and c) one or more polyorganosiloxanes with at least two NH₂ groups per molecule. In the rubber compositions the total quantity of organosilane is limited. The rubber compositions after vulcanization result in a good compression set.

The present invention relates to vulcanizable rubber compositions with a content in rubber that is amenable to amine crosslinking. The rubber composition further contains white filler. Furthermore, the invention relates to a vulcanized rubber which can be obtained by vulcanizing the rubber composition. In addition, the invention relates to the use of NH₂-functionalized polyorganosiloxanes in a vulcanizable rubber composition to reduce the compression set of the vulcanized rubber.

Rubbers that can be vulcanized with diamines can generally be processed to form vulcanizates with good cold resistance, high heat resistance and good mechanical properties. For crosslinking with amine, these rubbers are based on monomers with a functional group. Typically, the functional group is a carboxylic acid group. The best-known polymers that are accessible to amine crosslinking are acrylic rubbers (ACM), as produced for example by Unimatec and by Zeon, as well as ethylene acrylic rubbers (AEM), as can be obtained for example from DuPont. In addition, hydrogenated acrylonitrile butadiene rubber (HNBR rubber, e.g. from Zeon) can be crosslinked by means of amine.

Crosslinking during vulcanization typically proceeds via reaction with a primary diamine which forms an amide functionality with the crosslinking site in the polymer main chain. After crosslinking, the rubber compositions are, as a rule, further tempered for several hours at, for example, approximately 175° C. In the process, an imide functionality is produced by the reaction of an amide group with a carboxyl functionality in the polymer chain.

The use of white fillers in such rubber compositions is not widespread because white fillers lead to a deterioration of the compression set. It is however possible to improve the compression set through the use of organosilanes.

The compression set is an important parameter, for example for seals which require a high reset force. The parameter defines the behaviour of an elastomeric testpiece in the case of a constant deformation and subsequent decompression over a specific time period at a specific temperature. The reset force of an elastomeric testpiece is ascertained. Typical time periods for a compression set test are 24 h to 2000 h at temperatures of up to 200° C. After decompression, the testpieces are stored at room temperature for a defined time period and the height is then ascertained again. The permanent deformation can be calculated therefrom.

The more capable the elastomeric testpiece is of regaining its original height, the lower the value for the compression set is. A compression set of 0% means that the thickness ascertained before the deformation is regained, while a compression set of 100% indicates that no resetting takes place. In the present description the compression set is determined according to DIN ISO 815.

In rubber technology the use of organosilanes is generally widespread, in order to produce a join between reinforcing fillers (for example white fillers, such as silica) and the polymer used. Suitable silicas bear, on the surface, silanol (SiOH) groups, which can react with the alkoxy groups of an organosilane by means of condensation and accompanied by release of water, whereby a covalent bond between silica filler and silane is produced.

Such organosilanes are for example compounds which, in addition to functional alkoxy groups for bonding to the filler, bear a functionality that can bond with the polymer. In rubber processing, among other things, sulphur-containing silanes such as for example bis[3-(triethoxysilyl)propyl]tetrasulphide are widespread, while vinyl-containing organosilanes (for example vinyltriethoxysilane) are used in the case of peroxide crosslinking, and organosilanes with aminopropyl functionality (for example 3-aminopropyltriethoxysilane) are used in the case of amine crosslinking.

In HNBR rubber mixtures for amine crosslinking, it is possible to achieve relatively good results for the compression set with white fillers, even without the use of an organosilane. The values achieved in the vulcanizate for tensile strength and elongation at break are then acceptable. Through the addition, for example, of an aminosilane, it is then possible to further improve the compression set, but the further physical characteristics such as tensile strength and elongation at break prove to be worse. In particular, the elongation at break is greatly reduced.

EP 2 151 479 A1 discloses polyorganosiloxanes with 3 or more siloxane units, which have i) at least one organic moiety R¹, wherein R¹ has at least one carbon-carbon multiple bond, and ii) at least one hydrocarbon moiety R², wherein R² has a chain length of from 5 to 50 carbon atoms. EP 2 354 145 A1 relates to the use of polyorganosiloxanes with 3 or more siloxane units, which have i) at least one organic moiety R¹, wherein R¹ has at least one carbon-carbon multiple bond, and wherein the presence of hydrocarbon moiety with a chain length of from 5 to 50 carbon atoms is excluded, as an additive in the processing of rubber. The polyorganosiloxanes are used in the processing and vulcanization of rubber and are reactively incorporated therein. They result in a reduction in the viscosity of the rubber during the processing, and potentially an improvement in the mechanical properties of the vulcanized rubber.

EP 2 660 285 A1 discloses the vulcanization of rubber compositions which contain a nitrile rubber with a carboxyl group and a reactive silicone oil. These compositions can be processed to form crosslinked rubbers with low surface friction which, even in contact with oil, have the normal physical properties. Examples of functional groups of the reactive silicone oil according to EP 2 660 285 A1 are hydroxy, amino, mercapto, epoxy, carboxyl and (meth)acryl groups.

EP 2 660 285 A1 describes examples of compositions with a content in white filler, which further contain a comparatively high quantity of the reactive silicone oil (5 to 15 parts by weight, relative to 100 parts by weight of rubber, phr), and in addition typically 1 phr 3-aminopropyltriethoxysilane. The reactive silicone oil is singly functionalized with an NH₂ group, it is thereby not fixed in the rubber matrix and can, as a relatively non-polar material, to a certain extent diffuse out of the relatively polar rubber matrix and thus reduce the friction coefficient. The improvement in the compression set is small.

Consequently, the object of the present invention is to provide rubber compositions which contain white fillers and which can be processed to form vulcanizates with good mechanical characteristics. The vulcanizates are to have a good compression set in particular.

It has now surprisingly been found that the physical properties of rubbers vulcanizable with amine, which contain white, reinforcing fillers, are positively influenced by the addition of certain functionalized silicone oils (polyorganosiloxanes). Through the addition, according to the invention, of the polyorganosiloxanes functionalized at least twice with NH₂, it is above all possible to obtain high tensile strengths in conjunction with acceptable elongation at break and to improve the compression set. Advantageously, according to the invention, not only is little or no added organosilane needed, but the small quantity or the omission of organosilane improves the physical properties of the vulcanizates such that— compared with the exclusive use of an organosilane in usual concentrations—a clearly more balanced equilibrium results between compression set, elongation at break and tensile strength. It is assumed that the at least double functionalization with an NH₂ group in the polyorganosiloxanes used according to the present invention leads to a decisive improvement in the physical properties (such as compression set). In contrast, the reactive silicone oil mentioned by way of example in EP 2 660 285 A1 is only singly functionalized with an NH₂ group and correspondingly has a single link to the rubber matrix, and does not have the possibility of building up a second link or crosslinking.

According to the invention it is possible to work with a plurality of additives (including further fillers, such as carbon black), which is highly advantageous.

In addition it is possible, through the addition according to the invention of the NH₂-functionalized polyorganosiloxanes, to improve the processability of the rubber compositions. Positive effects are observed, for example, with respect to the release behaviour from metal surfaces. In addition, reducing the Mooney viscosity improves the flow of the compositions.

According to a first aspect, the present invention relates to a vulcanizable rubber composition which comprises
a) one or more rubbers that are crosslinkable with amine
b) one or more white fillers and
c) one or more polyorganosiloxanes with at least two NH₂ groups per molecule,
wherein
   (i) the total quantity of component c) is 0.1 to 8 parts by weight, relative to 100 parts by weight of component b), and
   (ii) the total quantity of organosilane in the rubber composition is at most 4 parts by weight, relative to 100 parts by weight of component b).

The vulcanizable rubber composition is preferably produced by mixing a) one or more amine-crosslinkable rubbers, b) one or more white fillers and c) one or more polyorganosiloxanes with at least two NH₂ groups per molecule, and optionally admixing the optionally present further constituents described below.

### 1) Vulcanizable Rubber Composition

a) Amine-Crosslinkable Rubber

The vulcanizable rubber composition according to the invention comprises a) one or more amine-crosslinkable rubbers. The amine-crosslinkable rubber is preferably selected from AEM, ACM and HNBR rubbers.

ACM rubbers are copolymers consisting of certain acrylates such as for example ethyl acrylate, n-butyl acrylate and alkoxyethyl acrylates. By adjusting the acrylates used and the proportions thereof, the desired properties such as temperature stability or resistance to certain fluids in the engine compartment of a car are achieved. Examples of acrylic rubbers are described in EP 2 660 285 A1.

A crosslinking site, such as for example a carboxyl group, is incorporated into the polymer chain of ACM rubbers. Types of ACM which can be crosslinked by means of diamines are also available, wherein the crosslinking monomer used is not named. Through the selection of the monomers, it is possible to increase the temperature stability of acrylic rubbers. Such types are marketed as HT-ACM rubber.

AEM rubbers are copolymers of ethylene and methyl acrylate, with a crosslinking site, typically a carboxyl functionality. By setting a certain proportion of ethylene and methyl acrylate, the properties at certain temperatures and resistance to certain fluids (motor oils and aggressive media in the engine compartment) can be controlled. For example, an increase in the methyl acrylate content increases resistance to non-polar motor oils.

HNBR rubbers are based on the monomers acrylonitrile and butadiene. Conventionally, HNBR rubbers can be crosslinked with peroxides and sulphur. They are described by the acrylonitrile content. A high acrylonitrile content leads to better resistance to certain fluid media. The tensile strength is also influenced positively. The higher the content of double bonds in the polymer chain, the more accessible the respective HNBR rubber to sulphur crosslinking. In addition to the monomers acrylonitrile and butadiene in the main chain, HNBR rubbers for crosslinking with diamines also have a suitable crosslinking site for amine crosslinking. HNBR rubbers can, for example, be obtained from Zeon. The available types (Zetpol HP) differ in the acrylonitrile content. A low acrylonitrile content increases low-temperature stability, while a high acrylonitrile content is very suitable for improving resistance to non-polar fluids, mineral oils or lubricants.

The quantity of component a), i.e. the total quantity of amine-crosslinkable rubber, is preferably 30 to 90 wt.-% relative to the weight of the vulcanizable rubber composition, preferably 40 to 80 wt.-%, in particular 50 to 70 wt.-%.

b) White Filler

The vulcanizable rubber composition according to the invention contains one or more white fillers as component b). Preferred white fillers are selected from silica, silicates, calcium carbonate, barium sulphate, aluminium hydroxide and magnesium hydroxide. These fillers can be surface-treated with silane.

Particularly preferred white fillers are selected from silica, silicates and calcium carbonate.

In particular component b) is silica.

Component b) is preferably present in the vulcanizable rubber composition according to the invention in a quantity of 5 to 200 parts by weight, preferably 10 to 100 parts by weight, such as 15 to 90 parts by weight, more preferably 20 to 80 parts by weight, in particular 30 to 70, such as 40 to 60 parts by weight, for example approximately 50 parts by weight, in each case relative to 100 parts by weight of rubber.

c) NH₂-Functionalized Polyorganosiloxane

In addition, the vulcanizable rubber composition according to the invention contains c) one or more functionalized polyorganosiloxanes with at least two NH₂ groups per molecule.

The polyorganosiloxane with at least two NH₂ groups per molecule preferably has the structural unit I

[R¹ₓ′ₐSiO_{[4-(x+a)]/2}] (I).

In this siloxane unit which, according to the present invention, is functionalized with a radical with an NH₂ group,
x is equal to 1, 2 or 3, and is preferably 1;
a is equal to 0, 1 or 2, and is preferably 1 or 2, in particular 1;
R is a monovalent radical selected from methyl, ethyl, propyl, phenyl or hydroxy, and R is particularly preferably methyl or hydroxy, in particular methyl; and
R¹ is a monovalent organic radical with NH₂ functionalization.

R¹ is preferably selected from
x) —R²—NH₂,
y) —R²—N(R³)—NH₂, and
z) —R²—N(R³)—R⁴—NH₂,

wherein
R² and R⁴ independently of each other are an alkylene or alkyleneoxy group with 1 to 20 carbon atoms, preferably an alkylene group with 1 to 5 carbon atoms, and
R³ is hydrogen or an alkyl group with 1 to 5 carbon atoms.

The at least two NH₂ groups per polyorganosiloxane molecule are preferably located in different groups R¹. The at least two NH₂ groups per polyorganosiloxane molecule are particularly preferably located in different structural units I. In particular the at least two NH₂ groups per polyorganosiloxane molecule are located in different structural units I^{D}.

Particularly preferably R¹ is x) —R²—NH₂, wherein R² is an alkylene group with 1 to 5 carbon atoms, preferably an alkylene group with 2 to 4 carbon atoms, in particular a prop-1,3-diyl group. R¹ is thus particularly preferably aminopropyl, NH₂(CH₂)₃—.

Preferred structural units I with x=1 are a side (difunctional, bridging) structural unit of type D with a=1:

[R¹RSiO_{2/2}] (I^{D})

and a structural unit at the end I (terminal structural unit I) of type M with a=2:

[R¹R₂SiO_{1/2}] (I^{M}).

It is particularly preferred that the groups R¹ with NH₂ functionality present according to the invention are arranged in side structural units of type I^{D}. Such polyorganosiloxanes used according to the invention are more easily accessible, as compared to polyorganosiloxanes with NH₂ groups on terminal siloxane groups (i.e. of type I^{M}).

In addition to the functionalized structural unit I mentioned and present according to the present invention (in particular of the side type I^{D}) with a radical with an NH₂ group, polyorganosiloxanes used according to the invention preferably additionally have the side structural unit II of type D:

[R′₂SiO_{2/2}] (II^{D})

wherein the radicals R′ are the same or different (and are preferably the same) and are selected from linear, branched or cyclic organic radicals which may be bound via an oxygen atom, and wherein the radicals R′ are preferably methyl, ethyl, propyl or phenyl, in particular methyl.

One or—particularly preferably—two terminal structural units III of type M are also preferably present in the polyorganosiloxane used according to the invention:

[R″₃SiO_{1/2}] (III^{M}),

wherein the radicals R″ are the same or different and are selected from hydroxy and linear, branched or cyclic organic radicals which may be bound via an oxygen atom and wherein the radicals R″ are preferably hydroxy, methyl, ethyl, propyl or phenyl, in particular hydroxy or methyl. In a particularly preferred embodiment, the radicals R″ are the same and are methyl groups. In a further particularly preferred embodiment, III^{M} is [(CH₃)₂(HO)SiO_{1/2}].

A preferred structure of a polyorganosiloxane used according to the invention is therefore as follows:

[I^{D}]ₘ[I^{M}]ₙ[II^{D}]ₒ[III^{M}]₍₂₋ₙ₎,

wherein
(i) m is in the range of from 0 to 40 and n may be 0, 1 or 2, provided that the sum (m+n) is at least 2, and wherein the sum (m+n) preferably is in the range up to 20.
(ii) o is in the range of from 0 to 1000 and
(iii) the sum (m+o+2) is at least 3.

In a preferred embodiment, the sum of the functionalized siloxane units in the polyorganosiloxanes used according to the invention, (m+n), is 2.0 to 15, more preferably 2.5 to 10, such as for example 3.0 to 8.0, in particular 4.0 to 6.0.

In a preferred embodiment, n is equal to zero (0), i.e. in the polyorganosiloxane the R¹ functionalization is preferably (substantially exclusively) contained in side structural units I^{D}. In this preferred embodiment, m is 2.0 to 15, more preferably 2.5 to 10, such as for example 3.0 to 8.0, in particular 4.0 to 6.0.

The side and NH₂-functionalized structural units I^{D} in the polyorganosiloxane used according to the invention are typically and preferably not arranged as a block, but are statistically distributed along the polysiloxane chain.

For a person skilled in the art, it is also apparent that the parameters m, n and o represent average values, because the polyorganosiloxanes used according to the invention are typically not obtained as defined compounds during production.

In an alternatively preferred embodiment, n is equal to 1 or 2 and preferably 2, i.e. in the polyorganosiloxane the R¹ functionalization is (at least also) contained in monofunctional (terminal) structural units I^{M}.

In a further preferred embodiment, the total number of siloxane units of the polyorganosiloxanes used according to the invention, (m+o+2), is 25 to 1000, more preferably 35 to 300, in particular 45 to 200, such as 55 to 155.

The number of side siloxane units II^{D} not substituted with groups R¹ (i.e. o) in the polyorganosiloxanes used according to the invention is preferably 20 to 1000, more preferably 30 to 300, in particular 40 to 200, such as 50 to 150.

NH₂-functionalized polyorganosiloxanes used according to the invention can be present as compounds with a high viscosity that are liquid at room temperature (25° C.)

Preferably, the total quantity of polyorganosiloxane NH₂-functionalized according to the invention, i.e. the quantity of component c), is in the range of from 0.2 to 7.0 parts by weight, preferably 0.5 to 6.5 parts by weight, more preferably 1.0 to 6.0 parts by weight, in particular 1.5 to 5.5, such as 2.0 to 5.0 parts by weight, in each case relative to 100 parts by weight of component b).

In a further preferred embodiment, the total quantity of component c) is 0.1 to 5.0 parts by weight, preferably 0.5 to 4.5 parts by weight, more preferably 0.8 to 4.0 parts by weight, more preferably 1.0 to 3.5 parts by weight, in particular 1.5 to 3.0 parts by weight, in each case relative to 100 parts by weight of rubber (phr).

Methods for producing the polyorganosiloxanes used according to the invention are known in the state of the art, wherein reference is made, e.g., to EP 2 660 285 A1.

d) Amine Crosslinker

The vulcanizable rubber composition according to the invention preferably further contains d) one or more amine crosslinkers, wherein the amine crosslinker is preferably a diamine, preferably an aliphatic or an aromatic diamine.

The amine-crosslinkable rubber is thus preferably a rubber that can be crosslinked with diamine.

The aliphatic diamine is preferably selected from hexamethylenediamine and hexamethylenediamine carbamate, wherein component b) is in particular hexamethylenediamine carbamate.

Preferred aromatic diamines are 2,2-bis[4-(4-aminophenoxy)phenyl]propane, 4,4-diaminodicyclohexylmethane and 4,4-diaminodiphenylether.

According to the invention it is preferred that the quantity of component d) is 0.1 to 10 parts by weight, preferably 0.2 to 8 parts by weight, more preferably 0.3 to 7 parts by weight, in each case relative to 100 parts by weight of rubber.

### Further Constituents

In addition to the already mentioned constituents a) to d), the vulcanizable rubber composition according to the invention further preferably contains
e) 0-200 parts by weight of one or more other fillers, preferably carbon black, relative to 100 parts by weight of rubber (phr),
f) 0-100 phr of plasticizer,
g) 0-8 phr of processing aid, wherein the processing aid is preferably selected from stearic acid, octadecylamine, phosphoric acid esters and mixtures thereof,
h) 0-8 phr of aging protection agent and/or
i) 0-10 phr of acceleration system.

### j) Limited Quantity of Organosilane

According to the invention, the quantity of organosilane is limited, in particular the quantity of organosilane functionalized with amino groups.

According to the present invention, the presence of one or more polyorganosiloxanes with at least two NH₂ groups per molecule is mandatory. Polyorganosiloxanes are characterized in that they contain Si—O chains, i.e. the silicon atoms are linked to adjacent silicon atoms by an oxygen atom. In contrast, organosilanes, the quantity of which is limited according to the invention, are characterized in that they have no Si—O—Si bonds. Examples of organosilanes the quantity of which is limited according to the invention are 3-aminopropyltriethoxysilane, 3-aminopropyltrimethoxysilane, 3-aminopropylmethyldiethoxysilane, bis-(3-triethoxysilylpropyl) amine and bis-(3-trimethoxysilylpropyl)amine.

The total quantity of organosilane in the vulcanizable rubber composition according to the invention is at most 4 parts by weight, relative to 100 parts by weight of component b). Preferably the total quantity is at most 3.5 parts by weight, such as at most 3 parts by weight, more preferably at most 2.5 parts by weight, such as at most 2.0 parts by weight or at most 1.5 parts by weight, in each case relative to 100 parts by weight of component b).

Particularly preferably the total quantity of organosilane in the rubber composition according to the invention is at most 1.0 parts by weight, particularly preferably at most 0.7 parts by weight, in particular at most 0.5 parts by weight or at most 0.3 parts by weight, in each case relative to 100 parts by weight of component b).

In a further preferred embodiment, the total quantity of organosilane in the rubber composition is limited to at most 2 parts by weight, relative to 100 parts by weight of rubber. The quantity of organosilane is preferably at most 1.5 parts by weight, such as at most 1.0 parts by weight, in particular at most 0.5 parts by weight, in each case relative to 100 parts by weight of rubber.

2) Use of the Polyorganosiloxanes Functionalized with NH₂ Groups

The polyorganosiloxanes functionalized with at least two NH₂ groups are used according to the invention for improving the compression set. In a further aspect, the invention thus relates to the use of polyorganosiloxanes with at least two NH₂ groups per molecule in a vulcanizable rubber composition which comprises
a) one or more amine-crosslinkable rubbers and
b) one or more white fillers,
   wherein
(i) the total quantity of polyorganosiloxane with at least two NH₂ groups per molecule in the rubber composition is 0.1 to 8 parts by weight, relative to 100 parts by weight of component b), and
(ii) the total quantity of organosilane in the rubber composition is at most 4 parts by weight, relative to 100 parts by weight of component b),
   to reduce the compression set of the vulcanized rubber.

In addition, the invention relates to a method for vulcanizing rubber, in which the vulcanizable rubber composition according to the invention is vulcanized at a temperature of for example 120° C. to 250° C.

### 3) Vulcanized Rubber and Article

In a further aspect, the invention relates to a vulcanized rubber which can be obtained by vulcanizing the vulcanizable rubber composition.

In a further aspect, the invention relates to an article which comprises the vulcanized rubber according to the invention. Examples of articles are such components which are exposed to high temperatures for longer periods of time and must in addition be resistant to aggressive media. This is the case in particular in automotive applications, for example for hoses in engine compartments, seals in engine compartments, oil sump gaskets, joint boots, insulation for connecting lines or for shock absorbers.

The advantages of the invention are apparent in particular from the following examples. All quantities, unless otherwise indicated, relate to the weight.

### EXAMPLES

The following chemicals were used (Table 1).

TABLE 1

| | | Manufacturer/ |
|---|---|---|
| Trade name | Explanation | Supplier |
| Zetpol | HNBR rubber for amine | Zeon |
| ZPT 136 | crosslinking (35% acrylonitrile | |
| | content), iodine number: 12 | |
| | g/100 g) | |
| Hytemp | HT-ACM rubber | Zeon |
| AR 12 | | |
| Vamac GLS | AEM rubber, Mooney viscosity | DuPont |
| | ML1′ + 4′ at 100° C. = 18.5 MU | |
| Ultrasil | Precipitated silica with a | Evonik Industries |
| VN2 GR | specific surface area of | |
| | 130 m²/g (multipoint method | |
| | based on ISO 9277) | |
| Aminosilane | 3-Aminopropyltriethoxysilane | Evonik Industries |
| Alcanplast | Trimellitic acid | ChemSpec Ltd. |
| TOTM | trimethylester, placticizer | |
| Alchem MBPA | 4-(1-methyl-1-phenylethyl)-N- | ChemSpec Ltd. |
| (CDPA) | [4-(1-methyl-1-phenyl-ethyl)- | |
| | phenyl]aniline, aging protection | |
| | agent (antioxidant) | |
| Edenor ST1 | Stearic acid, processing aid | Emery |
| | | Oleochemicals |
| Vanfre VAM | Polyoxyethylene-octadecylether- | Vanderbilt |
| | phosphate, processing aid | Chemicals LLC |
| DIAK#1 | Hexamethylenediamine carbamate, | DuPont Chemicals |
| | crosslinker | |
| Rhenogran | Accelerator for amine | RheinChemie |
| XLA-60 | crosslinking | Rheinau GmbH, |
| | | Mannheim |
| Luvomaxx | Aging protection agent 4-(1- | Lehmann & Voss & |
| CDPA | methyl-1-phenylethyl)-N-[4-(1- | Co. |
| | methyl-1-phenyl- | |
| | ethyl)phenyl]aniline | |
| Armeen 18 D | Octadecylamine, processing aid | AkzoNobel |
| | | Deutschland |
| Struktol KW | Polyetheradipate, plasticizer | Schill + Seilacher |
| 759 | | “Struktol” GmbH |
| Vulcofac | Activator/accelerator for amine | Safic Alcan |
| ACT 55 | crosslinking, tertiary amine | |
| | complex | |
| Corax N550 | Carbon black | Orion Engineered |
| | | Carbons |

Furthermore, the following polyorganosiloxanes were used according to the invention:

### POS 1-4

A polydimethylsiloxane with x dimethylsiloxane units, which additionally bears y primary amines statistically distributed in the side chain with a propyl spacer (i.e. R¹ is aminopropyl):
POS 1,2: x=100 y=4
POS 3: x=100 y=2
POS 4: x=200 y=8

### POS 5

A polydimethylsiloxane with 100 dimethylsiloxane units, which additionally bears 4 groups of the aminopropyl-aminoethyl type, statistically distributed in the side chain. There is consequently a secondary amine (NH) and a primary amine (NH₂) group in each functional group.

### Test Methods

Mooney viscosity: ISO 289-1 Rubber, unvulcanized—Determinations using a shearing-disc viscometer—Part 1: Determination of Mooney viscosity

Shore A hardness: DIN ISO 7619-1: 2012-02 Rubber, vulcanized or thermoplastic—Determination of indentation hardness—Part 1: Durometer method (Shore hardness)

Tensile strength/stress values/elongation at break: DIN 53504 Testing of rubber and elastomers—Determination of tensile strength at break, tensile stress at yield, elongation at break and stress values in a tensile test

Tear strength: DIN ISO 34-1 DIN Rubber, vulcanized or thermoplastic—Determination of tear strength—Part 1: Trouser, angle and crescent testpieces

Compression set: DIN ISO 815 Rubber, vulcanized or thermoplastic—Determination of compression set—Part 1: At ambient or elevated temperatures

### Example 1 (with HNBR Rubber)

A mixture of 100 parts by weight (=100 phr) of HNBR rubber (Zetpol ZPT 136), 50 parts by weight of silica (Ultrasil VN2 GR), 5 parts by weight of plasticizer (Alcanplast TOTM), 1.5 parts by weight of Alchem MBPA (CDPA), 1 part by weight of stearic acid and 1 part by weight of processing aid (Vanfre VAM) was produced in the upside down mixing process in a laboratory internal mixer and drawn out using a rolling mill, to form a rough sheet. The laboratory internal mixer had a volume of 1.5 l and tangential rotor geometry (1.5 N). The starting temperature was 60° C. and the speed was 55 rpm.

In the second production step, 4 parts by weight of accelerator (Rhenogran XLA-60), 2.6 parts by weight of the crosslinker (DIAK#1) and the amino-functionalized polyorganosiloxanes used were mixed using the rolling mill. The temperature of the rolling mill was 50° C. (water cooling).

### Example 2 (with HNBR Rubber)

100 parts by weight of HNBR rubber (Zetpol ZPT 136) were placed in a GK 1.5 N laboratory internal mixer at a starting temperature of 50° C. and a speed of 55 rpm. After 30 seconds, ⅔ of the quantity of silica (Ultrasil VN2 GR), the plasticizer (TOTM), the processing aids (Vanfre VAM and stearic acid) and the antioxidant (Alchem MBPA (CDPA)) were introduced. After 90 seconds (a further 60 seconds) ⅓ of the quantity of silica (VN2 GR) and (if provided) the NH₂-functionalized polyorganosiloxane was added. After 150 seconds the ram was vented and swept, and after 240 seconds (a further 90 seconds) the mixing process was ended and the mixture was discharged.

In the second production step, 4 parts by weight of accelerator (Rhenogran XLA-60) and 2.6 parts by weight of the crosslinker (DIAK#1) were mixed using the rolling mill. The temperature of the rolling mill was 50° C. (water cooling).

### Example 3 (with HT-ACM Rubber)

A mixture of 100 parts by weight (=100 phr) of HT-ACM rubber (Hytemp AR 12), 50 parts by weight of silica (Ultrasil VN2 GR), 5 parts by weight of plasticizer (Alcanplast TOTM), 1.5 parts by weight of (Alchem MBPA (CDPA)), 1 part by weight of stearic acid and 1 part by weight of processing aid (Vanfre VAM) was produced in the upside down mixing process in a laboratory internal mixer and drawn out using a rolling mill to form a rough sheet. The laboratory internal mixer had a volume of 1.5 l and tangential rotor geometry (1.5 N). The starting temperature was 30° C. and the speed was 70 rpm.

In the second production step, 2 parts by weight of accelerator (Rhenogran XLA-60) and 0.5 parts by weight of the crosslinker (DIAK#1) were mixed using the rolling mill. The temperature of the rolling mill was approx. 45° C. (water cooling).

For the vulcanization, the 2 mm test plates were vulcanized for 20 minutes and the 6 mm testpieces were vulcanized for 30 minutes at 190° C. All the vulcanized testpieces were then tempered in a drying cabinet for 4 h at 175° C.

Composition (parts by weight, Table 3):

TABLE 3

| | A1 | A2 |
|---|---|---|
| Hytemp AR 12 (HAT-ACM) | 100 | 100 |
| Ultrasil VN 2 GR | 50 | 50 |
| Alchem 445 (CDPA) | 2 | 2 |
| Stearic acid | 1 | 1 |
| Vanfre VAM | 1 | 1 |
| POS1 | | 1 |
| Rhenogran XLA-60 | 2 | 2 |
| Diak No 1 | 0.6 | 0.6 |
| Total | 156.6 | 157.6 |

The following results were obtained (Table 4):

TABLE 4

| | A1 | A2 |
|---|---|---|
| Shore A hardness [Sh E] | 63 | 63 |
| Tensile strength [MPa] | 9.8 | 11.4 |
| Elongation at break [%] | 371 | 317 |
| Modulus 100% [MPa] | 2.2 | 3.1 |
| Modulus 300% [MPa] | 7.4 | 10.5 |
| Tear strength [kN/m] | 4.4 | 3.3 |
| Compression set [%], | 94.5 | 70.7 |
| after 168 hours at 175° C. | | |

The compression set (CS) is clearly improved in the case of the HT-ACM rubber composition which contains the polyorganosiloxane POS1 used according to the invention (A1). Compared with the control composition without additive (A2), the CS is reduced by 23.8%. The value for tensile strength is also improved (increase from 9.8 MPa to 11.4 MPa). The improved compression set is also reflected in lower values for the elongation at break (from 371% to 317%) and for the tear strength.

### Example with HNBR #1

In these HNBR rubber compositions, the polyorganosiloxanes used according to the invention were mixed in during the first step (Table 5). For the vulcanization, the 2 mm test plates were vulcanized for 20 minutes and the 6 mm testpieces were vulcanized for 22 minutes at 170° C. All the vulcanized testpieces were then tempered in a drying cabinet for 4 h at 175° C.

A polyorganosiloxane used according to the invention was tested in two different concentrations in an HNBR rubber composition with silica, compared with an HNBR rubber composition with an aminosilane and compared with an HNBR control composition containing neither aminosilane nor polyorganosiloxane used according to the invention.

TABLE 5

| | B1 | B2 | B3 | B4 |
|---|---|---|---|---|
| Zetpol ZPT 136 | 100 | 100 | 100 | 100 |
| Ultrasil VN 2 GR | 50 | 50 | 50 | 50 |
| Alcanplast TOTM | 5 | 5 | 5 | 5 |
| Alchem MBPA (CDPA) | 1.5 | 1.5 | 1.5 | 1.5 |
| Stearic acid | 1 | 1 | 1 | 1 |
| Vanfre VAM | 1 | 1 | 1 | 1 |
| POS1 | | 2 | | |
| POS5 | | | 4 | |
| Aminosilane | | | | 1 |
| Diak No 1 | 2.6 | 2.6 | 2.6 | 2.6 |
| Rhenogran XLA-60 | 4 | 4 | 4 | 4 |
| Total | 165.1 | 167.1 | 169.1 | 166.1 |

The results are shown in Table 6 below.

TABLE 6

| | B1 | B2 | B3 | B4 |
|---|---|---|---|---|
| Shore A hardness [Sh E] | 68 | 68 | 70 | 72 |
| Tensile strength [MPa] | 21.5 | 23.6 | 23.6 | 16.2 |
| Modulus 100% [MPa] | 5.2 | 8 | 8.8 | n.a. |
| Elongation at break [%] | 277 | 209 | 185 | 96 |
| Compression set [%], | 44.7 | 29.5 | 27.4 | 24.1 |
| after 168 hours at 175% | | | | |
| Compression set [%], | 31.8 | 17.9 | 21.6 | 16.4 |
| after 168 hours at 150° C. | | | | |

By using aminosilane (rubber composition B4), it is possible to clearly reduce the compression set compared with the control composition B1. However, the values for tensile strength and elongation at break of B4 do not reach the starting values of composition B1. In particular, the elongation at break is clearly reduced, to values of approximately 100%, which would be too low for a practical application. Low values for the compression set may be desired, but only in combination with acceptable results for the elongation at break, which here lie clearly above 100%. On the other hand, through the addition of a polyorganosiloxane used according to the invention, it is achieved that the tensile strengths even lie above the value of the control composition B1 (see the rubber compositions B2 and B3). Moreover, lower compression sets are achieved, namely in combination with elongations at break which, although reduced compared with composition B1, are clearly higher than in the case of composition B4.

Example with HNBR #2:

In these HNBR rubber compositions, the polyorganosiloxanes used according to the invention were mixed in during the first step (Table 7). For the vulcanization, the 2 mm test plates were vulcanized for 20 minutes and the 6 mm testpieces were vulcanized for 22 minutes at 170° C. All the vulcanized testpieces were then tempered in a drying cabinet for 4 h at 175° C.

An examination was carried out, in which the following were compared:
the rubber compositions which contain low and high doses of aminosilane,
a rubber composition with a combination of aminosilane with a polyorganosiloxane used according to the invention as well as
a rubber composition which exclusively contained a polyorganosiloxane used according to the invention.

TABLE 7

| | C1 | C2 | C3 |
|---|---|---|---|
| Zetpol ZPT 136 | 100 | 100 | 100 |
| Ultrasil VN 2 GR | 50 | 50 | 50 |
| Alcanplast TOTM | 5 | 5 | 5 |
| Alchem MBPA (CDPA) | 1.5 | 1.5 | 1.5 |
| Stearic acid | 1 | 1 | 1 |
| Vanfre VAM | 1 | 1 | 1 |
| Aminosilane | 1.5 | 0.5 | 0.5 |
| POS5 | | | 2 |
| Diak No 1 | 2.6 | 2.6 | 2.6 |
| Rhenogran XLA-60 | 4 | 4 | 4 |
| Total | 166.6 | 165.6 | 167.6 |

The higher the dose of aminosilane, the lower the tensile strength (cf. Table 8). The values for the HNBR rubber composition C1, which contained 1.5 phr aminosilane, and the HNBR rubber composition C2, which contains 0.5 phr aminosilane, were 13.4 MPa and 21.0 MPa. The value of 16.2 MPa determined for the HNBR rubber composition (with 1.0 phr aminosilane) lies approximately between the tensile strengths of C1 and C2 (see B4).

The tensile strength is slightly reduced by the addition of a polyorganosiloxane used according to the invention, see HNBR rubber composition C3, in which an additional 2 phr of the polyorganosiloxane used according to the invention was added to 0.5 phr aminosilane.

Moreover, reducing the aminosilane dose from 1.0 phr to 0.5 phr only somewhat succeeds in improving the tensile strength or elongation at break, see B4 and C2.

The values which are achieved with the polyorganosiloxane used according to the invention remain unachieved with respect to the combination of tensile strength, elongation at break and compression set (see B2).

TABLE 8

| | C1 | C2 | C3 |
|---|---|---|---|
| Shore A hardness [Sh E] | 72 | 72 | 71 |
| Tensile strength [MPa] | 13.4 | 21.9 | 19.9 |
| Modulus 100% [MPa] | n.a. | 14.0 | 14.9 |
| Elongation at break [%] | 86 | 133 | 118 |
| Compression set [%], | 17.6 | 17.4 | 13.6 |
| after 168 hours at 150° C. | | | |

Example with HNBR#3:

In these HNBR rubber compositions, the polyorganosiloxanes used according to the invention were added with the crosslinking system of the HNBR rubber composition in the second step in the rolling mill (Table 9).

For the vulcanization, the 2 mm test plates were vulcanized for 20 minutes and the 6 mm testpieces were vulcanized for 22 minutes at 170° C. All the vulcanized testpieces were then tempered in a drying cabinet for 4 h at 175° C.

The HNBR rubber compositions D1 to D5 contain a control composition D1 without polyorganosiloxane used according to the invention (cf. Table 10). The HNBR rubber compositions D2 to D5 contained different polyorganosiloxanes used according to the invention with different numbers of functionalities and in different concentrations.

The following tests were carried out:
Different concentrations of a polyorganosiloxane used according to the invention (comparison of D2 and D3)
Different numbers of NH₂ functionalizations on polyorganosiloxanes used according to the invention at the same concentration in the respective HNBR rubber composition (comparison of D2 and D4)
The same ratio of amine functionalities to chain length of the polyorganosiloxanes used according to the invention at the same concentration used in the HNBR rubber composition (D2 and D5).

TABLE 10

| | D1 | D2 | D3 | D4 | D5 |
|---|---|---|---|---|---|
| Zetpol ZPT 136 | 100 | 100 | 100 | 100 | 100 |
| Ultrasil VN 2 GR | 50 | 50 | 50 | 50 | 50 |
| Alcanplast TOTM | 5 | 5 | 5 | 5 | 5 |
| Alchem MBPA (CDPA) | 1.5 | 1.5 | 1.5 | 1.5 | 1.5 |
| Stearic acid | 1 | 1 | 1 | 1 | 1 |
| Vanfre VAM | 1 | 1 | 1 | 1 | 1 |
| Rhenogran XLA-60 | 4 | 4 | 4 | 4 | 4 |
| Diak No 1 | 2.6 | 2.6 | 2.6 | 2.6 | 2.6 |
| POS2 | | 4 | 2 | | |
| POS3 | | | | 4 | |
| POS4 | | | | | 4 |

The results are shown in Table 11.

TABLE 11

| | D1 | D2 | D3 | D4 | D5 |
|---|---|---|---|---|---|
| Shore A hardness [Sh E] | 67 | 68 | 68 | 66 | 68 |
| Tensile strength [MPa] | 22.2 | 24.9 | 22.4 | 21.6 | 26.2 |
| Elongation at break [%] | 284 | 203 | 220 | 249 | 217 |
| Modulus 100% [MPa] | 4.4 | 7.8 | 6.6 | 5.4 | 6.5 |
| Tear strength [kN/m] | 5.5 | 2.8 | 3.8 | 3.6 | 2.9 |
| Compression set [%], | 38.1 | 22.2 | 23.5 | 24.9 | 22.1 |
| after 168 hours at 175° C. | | | | | |

The values for tensile strength indicate a dependence on the concentration used as well as on the number of NH₂ groups available per chain. The higher the concentration used of polyorganosiloxane used according to the invention in the HNBR rubber composition, the lower the compression set. The HNBR rubber composition D2 with 4 phr of polyorganosiloxane used according to the invention has a lower compression set than the composition D3, which contained only 2 phr of the same polyorganosiloxane used according to the invention.

If the number of NH₂ groups per polyorganosiloxane molecule is changed, a higher compression set results for polyorganosiloxanes used according to the invention which bear fewer NH₂ groups per molecule, if the concentration used in the HNBR rubber composition is the same (comparison of D2 and D4).

If the ratio of chain length and number of NH₂ groups present in the polyorganosiloxane used according to the invention is the same, an approximately comparable compression set results for the respective HNBR rubber compositions.

The values for the tensile strengths are approximately comparable to those of the control composition D1, but here too there is a clear tendency to higher tensile strength, the more NH₂ groups are present in the respective polyorganosiloxane used according to the invention.

Example with AEM Rubber (Vamac)

A mixture of 25 parts by weight of silica (Ultrasil VN2 GR), parts by weight of carbon black (N-550), 1.5 parts by weight of antioxidant (Luvomaxx CDPA), 10 parts by weight of plasticizer (Struktol KW 759), 1.5 parts by weight of stearic acid, 1 part by weight of processing aid (Vanfre VAM), 0.5 parts by weight of processing aid octadecylamine (Armeen 18 D) as well as, for the compositions E2 and E3, in each case 0.5 parts by weight of aminosilane was placed in a laboratory internal mixer in the upside down mixing process at 40° C. starting temperature and 50 rpm; after 30 seconds 100 parts by weight (=100 phr) of AEM rubber (Vamac GLS) were added.

Composition E5 contained no Vanfre VAM and only 1 phr of stearic acid.

After a further 1:30 minutes (in total after 2:00 minutes), in the case of the rubber compositions E3 to E5 (cf. Table 12) a specific quantity of the polyorganosiloxane used according to the invention was added in each case, and the laboratory internal mixer was closed again. After a total of 3:30 minutes, the mixing process was ended and the rubber composition was discharged. Immediately afterwards, the acceleration or crosslinking system was added to the rubber compositions in the rolling mill (water cooling, maximum cooling).

TABLE 12

| | E1 | E2 | E3 | E4 | E5 |
|---|---|---|---|---|---|
| Vamac GLS | 100 | 100 | 100 | 100 | 100 |
| Ultrasil VN2 GR | 25 | 25 | 25 | 25 | 25 |
| Corax N-550 | 30 | 30 | 30 | 30 | 30 |
| Struktol KW 759 | 10 | 10 | 10 | 10 | 10 |
| Luvomaxx CDPA | 2 | 2 | 2 | 2 | 2 |
| Stearic acid | 1.5 | 1.5 | 1.5 | 1.5 | 1 |
| Vanfre VAM | 1 | 1 | 1 | 1 | |
| Armeen 18D | 0.5 | 0.5 | 0.5 | 0.5 | 0.5 |
| Aminosilane | | 0.5 | 0.5 | | |
| POS1 | | | 1 | 1 | 2 |
| Vulcofac ACT 55 | 2 | 2 | 2 | 2 | 2 |
| Diak No 1 | 1.5 | 1.5 | 1.5 | 1.5 | 1.5 |
| Total | 173.5 | 174 | 175 | 174.5 | 174 |

For the vulcanization, all the testpieces were vulcanized for 10 minutes at 180° C. All the vulcanized testpieces were then tempered in a drying cabinet for 4 h at 175° C. The results are shown in Table 13.

TABLE 13

| | E1 | E2 | E3 | E4 | E5 |
|---|---|---|---|---|---|
| Shore A hardness [Sh E] | 67 | 73 | 74 | 70 | 71 |
| Tensile strength [MPa] | 16.3 | 16.1 | 15.8 | 17.2 | 17.2 |
| Elongation at break [%] | 372 | 222 | 210 | 285 | 226 |
| Modulus 100% [MPa] | 3.6 | 6.5 | 6.9 | 5 | 6.7 |
| Modulus 300% [MPa] | | | | | |
| Tear strength [kN/m] | 6.8 | 5.5 | 5.2 | 5.3 | 5.3 |
| Compression set [%], | 52.4 | 37.5 | 33.8 | 40.5 | 34.0 |
| after 70 h at 150° C. | | | | | |

Adding 1 part by weight of polyorganosiloxane used according to the invention thus succeeds in improving the Shore A hardness as well as the tensile strength (comparison of E1 with E4). Moreover, the compression set is improved by 11.9%. By adding aminosilane in Example E2 it is moreover possible to increase the Shore A hardness as well as the compression set. However, the value for the tensile strength remains at the level of the control composition E1 without aminosilane. Moreover, the elongation at break is reduced by 150%.

By using a combination of aminosilane and polyorganosiloxane according to the invention (E3), the compression set is reduced by a further 3.7% in comparison with Example E2, which only contains aminosilane.

The composition in Example E4 with the polyorganosiloxane used according to the invention thus has a greater tensile strength and a higher elongation at break than the composition in Example E2.

A doubling of the quantity used of polyorganosiloxane in Example E5 while dispensing with an aminosilane, 1 phr of Vanfre VAM and 0.5 phr of stearic acid leads to a reduction in the compression set to the level of Example E4 (with aminosilane and polyorganosiloxane).

1. Vulcanizable rubber composition, which comprises
a) one or more amine-crosslinkable rubbers,
b) one or more white fillers and
c) one or more polyorganosiloxanes with at least two NH₂ groups per molecule, wherein
i) the total quantity of component c) is 0.1 to 8 parts by weight, relative to 100 parts by weight of component b), and
ii) the total quantity of organosilane in the rubber composition is at most 4 parts by weight, relative to 100 parts by weight of component b).

2. Vulcanizable rubber composition according to claim 1, wherein the amine-crosslinkable rubber a) is selected from AEM, ACM and HNBR rubbers.

3. Vulcanizable rubber composition according to claim 1, wherein component a) is present in a quantity of 30 to 90 wt.-%, relative to the weight of the vulcanizable rubber composition.

4. Vulcanizable rubber composition according to claim 1, wherein the white filler is selected from silica, silicates, calcium carbonate, barium sulphate, aluminium hydroxide and magnesium hydroxide,
wherein the white filler is preferably selected from silica, silicates and calcium carbonate, in particular wherein component b) is silica.

5. Vulcanizable rubber composition according to claim 1, wherein component b) is present in a quantity of 5 to 200 parts by weight, preferably 10 to 100 parts by weight, such as 15 to 90 parts by weight, more preferably 20 to 80 parts by weight, in particular 30 to 70, such as 40 to 60 parts by weight, for example approximately 50 parts by weight, in each case relative to 100 parts by weight of rubber.

6. Vulcanizable rubber composition according to claim 1, wherein the polyorganosiloxane with at least two NH₂ groups per molecule has the structural unit I
[R¹ₓ′ₐSiO_{[4-(x+a)]/2}] (I),
wherein
x is equal to 1, 2 or 3, and is preferably 1,
a is equal to 0, 1 or 2, is preferably 1 or 2 and in particular is 1,
R is a monovalent radical selected from methyl, ethyl, propyl, phenyl or hydroxy, and R is particularly preferably methyl or hydroxy, in particular methyl, and
R¹ is a monovalent organic radical with NH₂ functionalization,
wherein R′ is preferably selected from
x) —R²—NH₂,
y) —R²—N(R³)—NH₂, and
z) —R²—N(R³)—R⁴—NH₂, wherein
R² and R⁴ independently of each other are an alkylene or alkyleneoxy group with 1 to 20 carbon atoms, preferably an alkylene group with 1 to 5 carbon atoms, and
R³ is hydrogen or an alkyl group with 1 to 5 carbon atoms,
wherein R¹ is in particular x) —R²—NH₂, and R² is an alkylene group with 1 to 5 carbon atoms, preferably an alkylene group with 2 to 4 carbon atoms, in particular a prop-1,3-diyl group.

7. Vulcanizable rubber composition according to claim 6, wherein the polyorganosiloxane has 2.5 to 10.0 structural units I, in particular 3.0 to 8.0 structural units I.

8. Vulcanizable rubber composition according to claim 1, wherein component c) is present in a quantity of 0.2 to 7.0 parts by weight, preferably 0.5 to 6.5 parts by weight, more preferably 1.0 to 6.0 parts by weight, in particular 1.5 to 5.5, such as 2.0 to 5.0 parts by weight, in each case relative to 100 parts by weight of component b).

9. Vulcanizable rubber composition according to claim 1, which further contains d) one or more amine crosslinkers,
wherein the amine crosslinker is preferably a diamine, preferably an aliphatic or an aromatic diamine.

10. Vulcanizable rubber composition according to claim 9, wherein the aliphatic diamine is selected from hexamethylenediamine and hexamethylenediamine carbamate, wherein component b) is in particular hexamethylenediamine carbamate.

11. Vulcanizable rubber composition according to claim 9, wherein the aromatic diamine is 2,2-bis[4-(4-aminophenoxy)phenyl]propane, 4,4-diaminodicyclohexylmethane or 4,4-diaminodiphenylether.

12. Vulcanizable rubber composition according to claim 9, wherein component d) is present in a total quantity of 0.1 to 10 parts by weight, preferably 0.2 to 8 parts by weight, more preferably 0.3 to 7 parts by weight, in each case relative to 100 parts by weight of rubber.

13. Vulcanizable rubber composition according to claim 1, which further comprises
e) 0-200 parts by weight of one or more other fillers, preferably carbon black, relative to 100 parts by weight of rubber (phr),
f) 0-100 phr of plasticizer,
g) 0-8 phr of processing aid, wherein the processing aid is preferably selected from stearic acid, octadecylamine, phosphoric acid esters and mixtures thereof,
h) 0-8 phr of aging protection agent and/or
i) 0-10 phr of acceleration system.

14. Vulcanized rubber, obtainable by vulcanizing the vulcanizable rubber composition according to claim 1.

15. Article, which comprises the vulcanized rubber according to claim 14.

16. Use of polyorganosiloxanes with at least two NH₂ groups per molecule in a vulcanizable rubber composition, which comprises
a) one or more amine-crosslinkable rubbers and
b) one or more white fillers,
wherein
(i) the total quantity of polyorganosiloxane with at least two NH₂ groups per molecule is 0.1 to 8 parts by weight, relative to 100 parts by weight of component b), and
(ii) the total quantity of organosilane in the rubber composition is at most 4 parts by weight, relative to 100 parts by weight of component b),
to reduce the compression set of the vulcanized rubber.
